(19) United States
(12) Patent Application Publication
(10) Pub. No.: US 2005/0232715 A1
(43) Pub. Date: Oct. 20, 2005

(54) Tool and toolholder for a hand tool machine

(76) Inventors: Otto Baumann, Leinfelden-Echterdingen (DE); Dietmar Saur, Gomaringen (DE); Michael Knuth, Hangzhou (DE)

Correspondence Address: Striker Striker & Stenby, 103 East Neck Road, Huntington, NY, 17743, US

(21) Appl. No.: 10/512,704

(22) PCT Filed: Aug. 28, 2003
(86) PCT No.: PCT/DE03/02862

§ 371 Date: Oct. 27, 2004

(30) Foreign Application Priority Data
Sep. 5, 2002 (DE) 102 41 054.2

(51) Int. Cl. B23B 51/00

(52) U.S. Cl. 408/226

(57) ABSTRACT

The tool and the tool holder each have two sections (18, 19, 20, 21) with different cross-sectional sizes arranged axially one behind the other. These sections (18, 19, 20, 21) on the tool shaft (3) and in the tool holder (1, 2) form reciprocal bearing surfaces. The first section (18) on the tool shaft (3) and the first section (20) of the tool holder (1, 2) have rotationally driving and locking means (5, 11, 12, 13, 14, 15, 16) which are operatively connected in a reciprocal manner.

A tool and a tool holder are provided which are very compact and wear-resistant. To this end, the rotationally driving and locking means (5, 11, 12, 13, 14, 15, 16) are arranged in parallel in the axial direction of the shaft (3) and/or the tool holder (1), and they are arranged in series relative to each other in the circumferential direction. In addition, the distance between the rotationally driving and locking means (5, 11, 12, 13, 14, 15, 16) in the first section (18, 20) of the shaft (3) and/or the tool holder (1) and the cross-sectional transition from the first section (18, 20) to the second section (19, 21) having the larger cross section is shorter than the region of the shaft (3) and/or the tool holder (1, 2) equipped with the rotationally driving and locking means (5, 11, 12, 13, 14, 15, 16).

### BACKGROUND INFORMATION

The present invention concerns a tool and a tool holder for a power tool, whereby the shaft of the tool includes two sections with different cross-sectional sizes positioned axially one behind the other, the sections forming bearing surfaces for corresponding sections in the tool holder, whereby the first section with the smaller cross section includes rotationally driving means and means for axial locking, the means being operatively connectable with corresponding means for rotationally driving and axially locking the tool provided in the tool holder, whereby the rotationally driving and locking means are positioned in parallel with each other in the axial direction of the shaft, and in series relative to each other in the circumferential direction of the shaft.

A tool holder for a drilling hammer is known from WO 01/53045 A1, for example, which is driven in a rotational and hammering manner. The tool holder has a holding body which is driven in a rotating manner by a machine coupled with the tool holder and into which the shaft of a tool can be inserted. Rotationally driving means are provided in the tool holder, which serve to transfer the rotation of the holding body to the shaft of the tool inserted therein. Typically, these rotationally driving means are composed of axially extending strips which are located in the receiving bore of the holding body, and engage in grooves provided in the shaft of the tool. Furthermore, locking means are provided in the tool holder that serve to fix the tool shaft in the tool holder in the axial direction. Typical locking means are composed of at least one locking ball which is located in a opening in the holding body of the tool body and is insertable in a recess provided in the shaft of the tool. In the locked position, the locking ball is covered radially outwardly by a locking sleeve. The locking sleeve is supported on the holding body in an axially displaceable manner. To release, the locking sleeve can be guided axially using an actuating sleeve into a release position in the direction of insertion of the tool against the force of a loaded spring. In this release position, play in the locking sleeve allows radial displacement of the locking ball from the recess in the tool shaft to release the tool.

A tool with a shaft is made known in EP 579 577 B1, which has two sections positioned axially one behind the other with different cross-sectional sizes. A tool holder described in this publication also has two sections with different cross-sectional sizes in a holding body for the tool shaft. The sections of the tool shaft and the sections of the holding body in the tool holder are configured such that bearing surfaces located on both sections of the tool holder have corresponding bearing surfaces on the two sections in the holding body of the tool holder. The first section with the smaller cross section of the tool shaft includes—as known from the known SDS-plus insertion systems, for example—rotationally driving and locking means which become operatively connected with corresponding means for rotational driving and axial locking located in the tool holder when the tool is inserted in the tool holder. These known rotationally driving and locking means are positioned in parallel in the axial direction of the shaft and in series relative to each other in the circumferential direction of the shaft. This arrangement of rotationally driving and locking means contributes to a shorter design of the tool holder and the tool shaft. The second section with the larger shaft cross section follows—at a relatively large distance—the locking and rotationally driving means in the first section with the smaller cross section. As a result, the first section has a very long length, which results in the tool shaft also having a large overall length. The second section with the larger cross section is provided with a large number of axially extending grooves around its entire circumference, into which corresponding segments engage in the second section of the tool holder. The purpose of this geometry of the second section is to obtain the highest possible transfer or torque from the holding body of the tool holder to the tool shaft.

Based on experience, tool holders and the tools inserted therein are subject to high loads due to the transfer of impact and torque when used for drilling and/or hammering. This causes the tool holder to wear in a manner such that the receiving opening for the tool in the holding body becomes wider after extended use. The mouth of the receptacle is spread apart in the manner of a trumpet. As a result, tool guidance becomes poorer.

The invention is based on the task of providing a tool and an associated tool holder of the type stated initially which have the most compact design possible and are as wear-resistant as possible.

### ADVANTAGES OF THE INVENTION

The stated task having the features of Claim 1 is fulfilled with regard for the embodiments of the tool by the fact that the distance between the rotationally driving and locking means provided in the first section of the tool shaft and the cross-sectional transition from the first section to the second section having the larger cross section is shorter than the region of the shaft equipped with the rotationally driving and locking means. With regard for the tool holder, the stated task is fulfilled by the fact that the distance between the rotationally driving and locking means provided in the first section of the tool holder and the cross-sectional transition from the first section to the second section in the tool holder having the larger cross section is shorter than the region of the tool holder equipped with the rotationally driving and locking means.

Due to the fact that two sections are provided on the tool shaft and in the tool holder, a more exact guidance of the tool in the tool holder is obtained. The guidance, mainly in the mouth region of the holding body, is improved by providing this section with a larger cross section. This larger cross section is accompanied by a larger bearing surface on the tool shaft in the second region of the tool holder. This results in a very narrow tool guide, with the result that wear in the region of the mouth of the holding body of the tool is reduced and the mouth of the holding body therefore does not widen as quickly in the shape of a trumpet. This more exact tool guidance improves the rotation of the tool, enabling more precise boring to be carried out.

Advantageous further developments of the present invention result from the dependent claims.

The rotationally driving and/or locking means can terminate in the first section before the cross-sectional transition from the larger cross section to the second section, or they can extend past the cross-sectional transition to the second section. For the manufacturing process, it is simpler when both sections have identical cross-sectional shapes, at least in the regions forming the bearing surfaces. Round cross sections are particularly advantageous. A particularly advantageous effect is obtained for the tool guidance and, therefore, for an exact rotation of the tool with very low wear of the holding body, in particular in its mouth region, when most of the second section having the larger cross section has a smooth surface without any notches or raised areas.

The rotationally driving and/or locking means on the tool shaft can be recesses provided in the bearing surface of the first section or raised areas projecting out of the bearing surface. The rotationally driving and locking means in the tool holder are designed to be complimentary with the recesses or raised areas.

### DRAWING

The present invention is described in greater detail below with reference to the exemplary embodiment presented in the drawing.

FIG. 1 shows a longitudinal sectional view through a tool holder with a tool inserted therein,

FIG. 2 shows a cross section D-D through the tool holder with a tool inserted therein,

FIG. 3 shows a longitudinal sectional view through the tool holder with a tool inserted therein, the view being rotated by 90° compared to the depiction in FIG. 1,

FIG. 4 shows a side view of the tool shaft with a view of a rotationally driving groove,

FIG. 5 shows a longitudinal sectional view through the tool shaft,

FIG. 6 shows a side view of the tool shaft with a view of a dome-shaped recess for locking the tool, and

FIG. 7 shows a perspective illustration of the tool shaft.

### DETAILED DESCRIPTION OF THE EMBODIMENTS

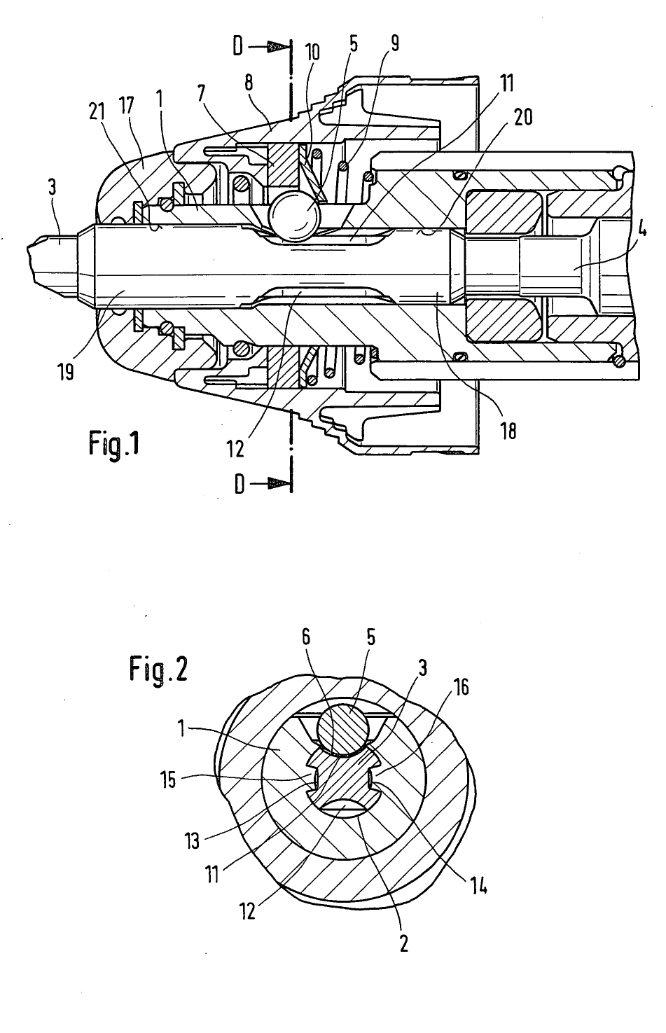

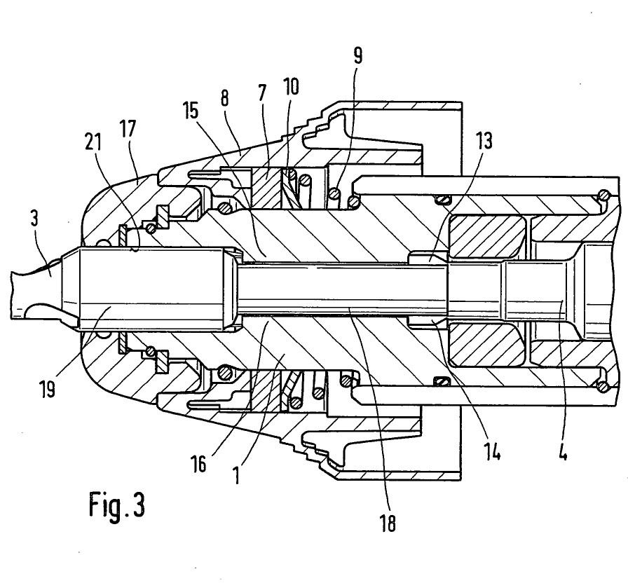

The two longitudinal sectional views shown in FIGS. 1 and 3 and rotated by 90° relative to each other, and the cross section D-D through a tool holder with a tool inserted therein shown in FIG. 2 illustrate the design and function of the tool holder and the tool.

An essential component of the tool holder is a holding body 1 with a central receiving opening 2 into which shaft 3 of a tool is insertable. The tool holder is coupled with a power tool, e.g., a drilling hammer or an impact drill (not shown in the drawing) such that holding body 1 is driven in a rotating manner by the drive spindle of the power tool. A striking pin 4 extends into receiving opening 2 of holding body 1 from the machine side, the striking pin impacting shaft 3 of the tool (e.g., a drill or chipping hammer) in an axial direction when the machine is in striking mode.

Tool shaft 3 must be locked in the axial direction in the receiving opening 2 of holding body 1, and the torque of the rotationally driven holding body must be transferred to shaft 3 of the tool. The means for axially locking tool shaft 3 have a locking ball 5 which is supported in a radially displaceable manner in the wall of holding body 1. Part of locking ball 5 can dip into receiving opening 2 of holding body 1, whereby a conically formed opening 6 in the wall of holding body 1 prevents locking ball 5 from dipping completely into receiving opening 2. Locking ball 5 is covered radially by retaining ring 7 which radially surrounds holding body 1, and this retaining ring 7 is axially displaceable via an actuating sleeve 8 which wraps around holding body 1. A spring 9 acts on retaining ring 7 with an axial force in the direction of the locking position, in which retaining ring 7 covers locking ball 5. A retaining plate 10 is located between spring 9 and retaining ring 7, which retracts axially against the force of the spring when shaft 3 of the tool is inserted. Retaining ring 7 must be actuated only to release shaft 3. The two views of the tool holder with the tool inserted therein shown in FIGS. 1 and 2 show the locked position of locking ball 5. In this locked position, locking ball 5 dips through opening 6 into receiving opening 2 and into a dome-shaped recess 11 provided in tool shaft 3. A further dome-shaped, diametrically opposed recess 12 makes it possible to also insert the tool in the tool holder rotated by 180° around its longitudinal axis. The dome-shaped recesses 11, 12 have a certain axial expansion, so that an axial motion of the tool in holding body 1 is possible when the power tool is in striking mode. The front sides of the dome-shaped recesses 11, 12 limit the axial motion of tool 3 in its locked position.

To release the tool, actuating sleeve 8 is used to push retaining ring 7 against retaining plate 10 and against spring 9 which loads retaining plate 10 such that locking ball 5 can move radially outwardly out of dome-shaped recess 11, 12 of shaft 3, and the tool can be removed from holding body 1.

The means for rotationally driving the tool are composed, on the shaft side, of rotationally driving grooves 13, 14 formed in the shaft and extending in the axial direction; on the side of holding body 1, the means are composed of rotationally driving segments 15 and 16 which engage in rotationally driving grooves 13 and 15 of shaft 3, the rotationally driving segments being located in receiving opening 2 in a radially inwardly projecting manner.

A dust protection cap 17 is mounted on holding body 1 on the end with the tool, the dust protection cap surrounding tool shaft 3 in a form-locked manner and also creating an interlocking connection with actuating sleeve 8, so that the tool holder is protected against dust penetration on the tool side.

The rotationally driving and locking means can have different geometries than those shown in FIGS. 1, 2 and 3 described above. For example, instead of rotationally driving grooves 13, 14 provided in shaft 3, raises areas which project radially from the circumference of shaft 3 can also be provided, the raised areas extending into corresponding grooves in receiving opening 2 of holding body 1. This would allow rotationally driving grooves 13, 14 and rotationally driving segments 15, 16 to be reversed. The locking mechanism can also have a different design. For example, instead of a locking ball, a locking body of any other type can be provided, and other geometries of recesses 11, 12 in shaft 3 can also be used accordingly.

Independent of the geometry of the rotationally driving and locking means, shaft 3 of the tool has two sections 18 and 19 having different cross-sectional sizes and located with one behind the other. First section 18 with the smaller cross section faces striking pin 4. Second section 19 with the larger cross section faces the tool insertion opening in the tool holder. Both sections 18 and 19 of shaft 3 of the tool have corresponding sections 20 and 21 in holding body 1 of the tool holder. First section 20 of holding body 1 on the machine side has a smaller cross section of receiving opening 2 than second section 21, which is located in the region of the tool insertion opening.

First sections 18 and 20 of shaft 3 and holding body 1, and second sections 19 and 21 of shaft 3 and holding body 1 are matched to each other in terms of dimensions and shape such that they form reciprocal bearing surfaces and therefore allow exact guidance of tool shaft 3 in receiving opening 2 of holding body 1. Due to the fact that two sections 18, 20 and 19, 21 which form reciprocal bearing surfaces are provided on tool shaft 3 and in holding body 1 of the tool holder, tool shaft 3 is subjected to particularly good guidance in the tool holder. Due, in particular, to the enlarged cross section of second section 19, 21 on the tool shaft and in the holding body 1 in the region of the insertion opening in the tool holder on the tool side, the surface load—which is particularly strong in this region—is distributed over a larger bearing surface of second section 19, 21. As a result, much less wear occurs in the region of the insertion opening of holding body 1.

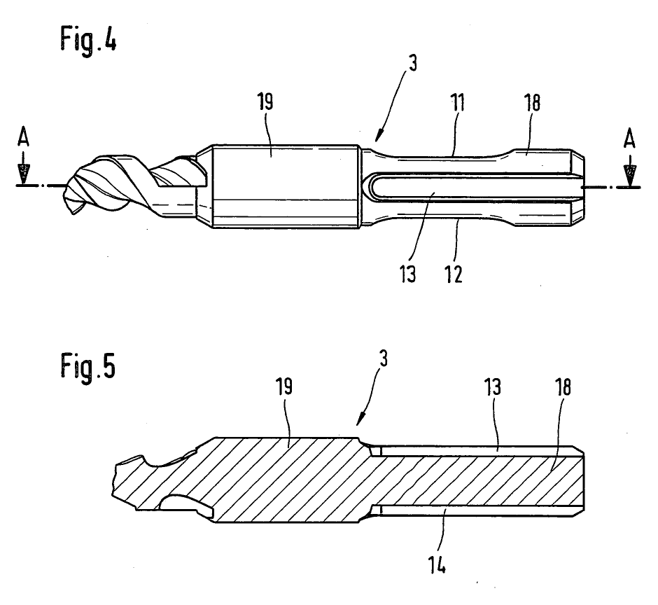

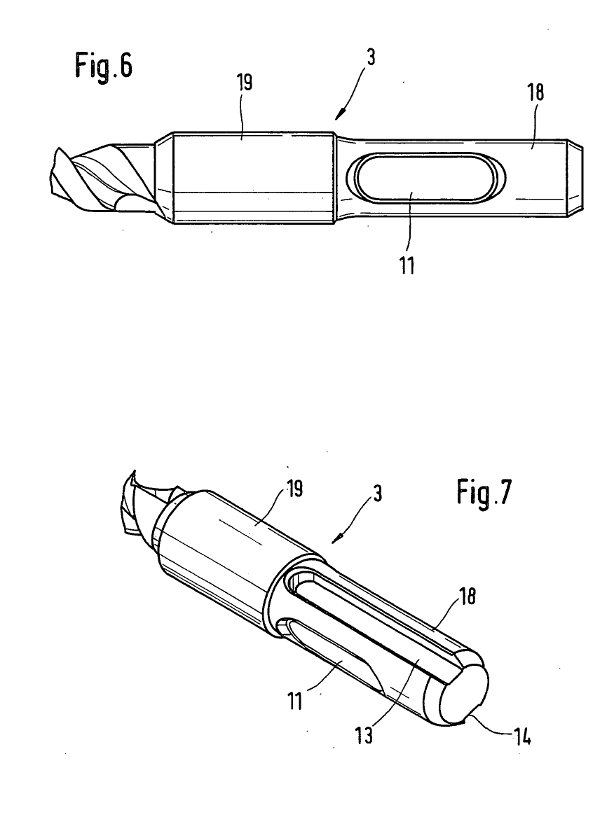

In FIGS. 4 through 7, tool shaft 3 is shown removed from the tool holder, to clarify the geometry of tool shaft 3 once more. FIG. 4 shows a side view of tool shaft 3 with a view of a rotationally driving groove 13. FIG. 5 shows a longitudinal sectional view A-A through this tool shaft 3. FIG. 6 shows a side view of this tool shaft 3 with a view of the dome-shaped recess 11, and FIG. 7 shows a perspective drawing of tool shaft 3. The two sections 18 and 19 arranged axially one behind the other having different cross-sectional sizes are shown in the illustrations in FIGS. 4 through 7. Preferably, the two sections 18 and 19 are cylindrical, that is, their cross-sectional shapes are essentially round. Other cross-sectional shapes of the first and second section 18, 19 are also permitted, just as it is permissible for the cross-sectional shapes of the two sections 18 and 19 to deviate from each other.

The illustrations of tool shaft 3 in FIGS. 4 through 7 make it clear that the length of first section 18 is such that the rotationally driving and locking means extending in the longitudinal direction—provided in the form of rotationally driving grooves 13, 14 and dome-shaped recesses 11, 12 in this case—have adequate space in this section. First section 18 should also be kept so short that the distance between rotationally driving and locking means 11, 12, 13, 14 provided therein and the cross-sectional transition from first section 18 to second section 19 having the larger cross section is shorter than the region of shaft 3 equipped with rotationally driving and locking means 11, 12, 13, 14. This condition results in a very short design of tool shaft 3 and balanced dimensions between the guide surfaces of the two sections 18 and 19, and rotationally driving and locking means 11, 12, 13, 14.

In the exemplary embodiment of tool shaft 3 shown in FIGS. 4 through 7, rotationally driving and locking means 11, 12, 13, 14 terminate in front of the cross-sectional transition to the larger cross section of second section 19. As an alternative, rotationally driving and/or locking means 11, 12, 13, 14 can also extend past the cross-sectional transition to second section 19. In this case, however, rotationally driving and/or locking means 11, 12, 13, 14 should extend into section section 19 with the larger cross section only so far that most of this section section has a smooth surface without any notches or raised areas. This therefore provides the second section, in the tool holder, with a good guiding property, because second section 19 forms a very large bearing surface in the tool holder, which results in a reduction in the surface load. As a result, the tool holder experiences less wear in the region of the tool insertion opening.

1. A tool with a shaft (3) which is insertable in a tool holder of a power tool, the shaft having two sections (18, 19) with different cross-sectional sizes arranged axially one behind the other, the sections forming bearing surfaces for corresponding sections (20, 21) in the tool holder (1, 2), whereby the first section (18) with the smaller cross section includes rotationally driving means (13, 14) and means (11, 12) for axial locking, which are capable of being operatively linked with corresponding means provided in the tool holder (1, 2) for driving (15, 16) and axially locking (5) the tool, whereby the rotationally driving and locking means (11, 12, 13, 14) are positioned in parallel in the axial direction of the shaft (3) and in series relative to each other in the shaft circumferential direction,
wherein the distance between the rotationally driving and locking means (11, 12, 13, 14) provided in the first section (18) of the shaft (3) and the cross-sectional transition from the first section (18) to the second section (19) having the larger cross section is shorter than the region of the shaft (3) equipped with the rotationally driving and locking means (11, 12, 13, 14).

2. The tool as recited in claim 1,
wherein the rotationally driving and locking means (11, 12, 13, 14) terminate in the first section (18) in front of the cross-sectional transition to the larger cross section of the second section (19).

3. The tool as recited in claim 1,
wherein the driving and/or locking means (11, 12, 13, 14) extend past the cross-sectional transition to the second section (19).

4. The tool as recited in claim 1,
wherein both sections (18, 19) have identical cross-sectional shapes, at least in the areas which form the bearing surfaces.

5. The tool as recited in claim 4,
wherein the cross-sectional shapes are round.

6. The tool as recited in claim 1,
wherein most of the second section (19) has a smooth surface without any notches or raised areas.

7. The tool as recited in claim 1,
wherein the rotationally driving means (13, 14) and/or the locking means (11, 12) are either recesses in the bearing surface of the first section (18) or raised areas projecting out of the bearing surface.

8. A tool holder of a power tool for a tool with a shaft (3), which has two sections (18, 19) positioned axially one behind the other and having different cross-sectional sizes, which form bearing surfaces for corresponding sections in the tool holder (1, 2), whereby the first section (20) with the smaller cross section in the tool holder (1, 2) includes rotationally driving means (15, 16) and means (5) for axial locking, which are capable of being operatively locked with corresponding means provided on the tool shaft (3) for driving (11, 12) and for axially locking (13, 14) the tool, whereby the rotationally driving and locking means (5, 15, 16) are positioned in parallel in the axial direction of the tool holder (1, 2) and in series relative to each other in the circumferential direction of the tool holder (1, 2),
wherein the distance between the rotationally driving and locking means (5, 15, 16) provided in the first section (20) of the tool holder (1, 2) and the cross-sectional transition from the first section (20) to the second section (21) having the larger cross section in the tool holder (1, 2) is shorter than the region of the tool holder (1, 2) equipped with the rotationally driving and locking means (5, 15, 16).

9. The tool holder as recited in claim 8,
wherein the rotationally driving and locking means (15, 16) terminate in the first section (20) in the tool holder (1, 2) in front of the cross-sectional transition to the larger cross section of the second section (21) in the tool holder (1, 2).

10. The tool holder as recited in claim 8,
wherein the driving and/or locking means (5, 15, 16) extend past the cross-sectional transition to the second section (19) in the tool holder (1, 2).

11. The tool holder as recited claim 8,
wherein both sections (20, 21) in the tool holder (1, 2) have identical cross-sectional shapes, at least in the regions forming the bearing surfaces.

12. The tool holder as recited in claim 11,
wherein the cross-sectional shapes are round.

13. The tool holder as recited claim 8,
wherein most of the second section (21) in the tool holder (1, 2) has a smooth surface without any notches or raised areas.

14. The tool holder as recited in claim 8,
wherein the rotationally driving means (15, 16) and/or the locking means (5) are either recesses in the bearing surface of the first section (20) of the tool holder (1, 2), or they are raised areas projecting out of the bearing surface.
